(19) United States
(12) Patent Application Publication
(10) Pub. No.: US 2026/0351624 A1
(43) Pub. Date: Nov. 5, 2026

(54) METHOD FOR IMPROVING ELECTRODE ACTIVITY

(71) Applicant: DUBAI ELECTRICITY AND WATER AUTHORITY PJSC, Dubai (AE)

(72) Inventors: Abdulmonem FETYAN, Dubai (AE); Anugrah ANDISETIAWAN, Dubai (AE); Ayoob MOHAMED SABT ALI ALHAMMADI, Dubai (AE)

(21) Appl. No.: 19/485,530

(22) PCT Filed: Mar. 25, 2024
(86) PCT No.: PCT/IB2024/052852

§ 371 Date: Nov. 18, 2025

(30) Foreign Application Priority Data
May 23, 2023 (AE) P6001218/2023

(51) Int. Cl. H01M 4/88; H01M 4/90; H01M 8/18

(52) U.S. Cl. CPC H01M 4/8846; H01M 4/8882; H01M 4/9008; H01M 8/188

(57) ABSTRACT

The present invention discloses a method for improving electrode activity by increasing hydrophilicity and number of functional groups on the surface of the electrode, including the steps of providing a polymer as electrochemical catalyst for the electrode or electrodes, preparing a polymer solution, allowing the heating of the polymer solution to a set temperature, immersing the electrode or electrodes in the polymer solution, stirring the solution, removing the electrode or electrodes from the solution and allowing the electrodes to cool to room temperature, and applying a thermal treatment step to provide an activated electrode or electrodes, whereas the polymer is a bio-derived polymer.

### FIELD OF INVENTION

The present invention relates to an electrode activation method. The present invention more particularly relates to a method for improving electrode activity and wettability.

### BACKGROUND TO THE INVENTION

Conventional energy sources, such as fossil fuel and nuclear fuel, remain amongst the primary energy sources utilized for electricity generation around the world. It is known, however, that these energy sources have some drawbacks, especially in respect of negative environmental impact. For this reason, there has been a mounting interest in the use and development of renewable energy sources.

For example, in 2017, the United Arab Emirates launched its ‘Energy Strategy 2050’. Amongst others, this strategy aims to increase the percentage of clean energy to 50 percent by 2050. It also aims to reduce the carbon footprint of power generation by 70 percent. The Dubai government, specifically, set a goal to reach 75 percent clean energy to be harvested from renewable sources by 2050.

The utilization of various renewable energy sources, subsequently however, requires large-scale energy storage systems which are reliable, durable, economical, and long lasting.

Redox flow batteries (RFB) show great promise as such a storage system for electrical energy. Several factors contribute to this, such as low environmental impact, scalability, long cycle life (number of cycles >1000), its negligible self-discharge, and decoupled energy and power density.

A typical redox flow system consists of stacked cells (where reactions take place), storage tanks (where electrolytes are stored), and pumps (to circulate the electrolytes between the stacks and tanks). Redox flow batteries store energy in the liquid electrolytes recirculated through the external tanks. Carbon felts (CF) are usually used as electrodes in, for example, vanadium RFBs (VRFB).

However, CFs normally exhibit poor electrochemical activity, resulting in poor overall performance of the VRFB system. Furthermore, RFBs can have low energy density, low power density, and low efficiency, which may require additional space and infrastructure, in turn, increasing the overall cost of RFB systems. This can make them less competitive compared to other batteries. Even further, RFB electrodes can suffer degradation phenomena over cycling, thereby shortening the usage window of current density. This may result in low power and decreased efficiency over cycling.

Various methods are known in the art for increasing the current/energy density and electrode stability over cycling in RFB systems. Specifically, several approaches are known for improving the carbon felt electrode's catalytic activity, such as thermal treatment, acid treatment, base etching, and the deposition of metals and metal oxides on the surface of the electrode(s) to activate the felts.

Drawbacks associated with these activation methods are as follows: Thermal treatment (most used) and acid treatment demonstrates limited improvement and poor stability, whereas base etching and deposition of metals and metal oxides involve a high temperature step (>900° C.) which has a high cost associated with it.

### OBJECT OF THE INVENTION

It is therefore, an object of the present invention to provide a method for improving electrode activity to address the issues identified above, which provides a useful alternative to existing technologies.

### SUMMARY OF THE INVENTION

Accordingly, as per one aspect of the present invention, a method for improving electrode activity provided, wherein the method includes the steps of:
dissolving a linear polymer in a solvent in the concentration ranging between from 0.05 wt % to 5 wt % at a temperature ranging between from 60° C. to 100° C., obtain a polymer solution;
immersing the electrode(s) in the polymer solution at temperature ranging between 60° C.-100° C., and stirring the solution for the time period ranging between 5 minutes to 15 minutes;
removing the electrode(s) from the polymer solution and allowing the electrode(s) to cool to the temperature ranging between 15° C. to 30° C.; and
thermally treating the obtained electrode(s) at a temperature ranging between 350° C. to 420° C. for a time period ranging between 1-10 hours, for receiving electrode with improved activity.

In another aspect of the present invention, the bio-derived polymer may have hydrophilic functional groups.

In another aspect of the present invention, the bio-derived polymer may be selected from the group consisting of agar powder, chitosan, gelatin, dextran, cellulose, starch, natural rubber, pectin, etc.

In another aspect of the present invention, the weight percent polymer solution may be in the range of 0.05 wt %-5 wt %.

In another aspect of the present invention, the polymer solution may be preferably a 0.5 wt % agar polymer solution.

In another aspect of the present invention, the electrode(s) may be selected from the group consisting of carbon felts, carbon cloth, carbon powders, carbon sheets, carbon fiber, carbon nanotubes.

In another aspect of the present invention, the solvent for the preparation of polymer solution may be selected from aqueous solvent.

In another aspect of the present invention, the set temperature to which the polymer solution is heated may in the temperature ranging between 60° C.-90° C., preferably at 80° C.

In another aspect of the present invention, the thermal treatment step is done in the temperature ranging between 350° C.-420° C., for the time-period ranging between 1-4 hours, preferably, the thermal treatment step may be done at 400° C. for 2 hours.

In another aspect of the present invention, the electrode or electrodes may be used as negative or positive side electrodes in energy storage systems.

In another aspect of the present invention, the energy storage systems may be selected from the group including redox flow batteries, vanadium redox flow batteries, supercapacitor, electrolysters, fuel cell and the like.

In another aspect of the present invention, the electrode activity may be improved by improving the electrode catalytic activity.

In another aspect of the present invention, the electrode catalytic activity may be improved by increasing the hydrophilicity and number of functional groups on the surface of the electrode during the thermal treatment step.

In another aspect of the present invention, the increasing number of functional groups is achieved by the integration of oxygen-containing groups on the surface of the electrodes.

In another aspect of the present invention, the integration of oxygen-containing group is selected from the group consisting of alcohols, ether, aldehydes, ketone, carboxylic acid, ester, acid halides, etc.

In another aspect of the present invention, the integration of these functional groups on the surface of the carbon felts may increase the surface-active sites, which may aid in catalyzing electrolyte species at higher current density compared to only heat-treated carbon felt.

### BRIEF DESCRIPTION OF THE DRAWINGS

The invention will now be described further by way of non-limiting examples with reference to the accompanying drawing wherein:

FIG. 1 shows respective SEM images of a) HT-CF used as reference electrode versus b) agar-modified CF electrode prepared in accordance with the method of the present invention, wherein the inset shows oxygen mapping via EDX, in accordance with one embodiment of the invention;

FIG. 2 shows the polarization curves of 0.5% agar loaded CF compared to HT-CF, before and after 50 cycles of charging and discharging at 50% state of charge, in accordance with another embodiment of the invention;

FIG. 3 shows the energy efficiency (EE) and coulombic efficiency (CE) of 0.5% agar loaded CF and HT-CF, respectively, in accordance with one embodiment of the invention; and

FIG. 4 shows the state of charge (SOC) extracted from open circuit voltage measurement after each cycle for 0.5% agar loaded CF and HT-CF, in accordance with one embodiment of the invention, respectively.

### DETAILED DESCRIPTION OF THE INVENTION

The present invention may be understood more readily by reference to the following detailed description of the invention taken in connection with the accompanying drawing figures, which forms a part of this disclosure. It is to be understood that this invention is not limited to the specific devices, methods, conditions, or parameters described and/or shown herein and that the terminology used herein is for the example only and is not intended to be limiting of the claimed invention.

Also, as used in the specification including the appended claims, the singular forms ‘a’, ‘an’, and ‘the’ include the plural, and references to a particular numerical value includes at least that particular value unless the content clearly directs otherwise. Ranges may be expressed herein as from ‘about’ or ‘approximately’ another particular value when such a range is expressed another embodiment. Also, it will be understood that unless otherwise indicated, dimensions and material characteristics stated herein are by way of example rather than limitation and are for better understanding of sample embodiment of suitable utility, and variations outside of the stated values may also be within the scope of the invention depending upon the particular application.

Embodiments will now be described in detail with reference to the accompanying drawings. To avoid unnecessarily obscuring the present disclosure, well-known features may not be described or substantially the same elements may not be redundantly described, for example. This is for ease of understanding.

The following description is provided to enable those skilled in the art to fully understand the present disclosure and are in no way intended to limit the scope of the present disclosure as set forth.

The embodiments described herein provide a method for improving electrode activity.

According to one embodiment of the present invention, a method for improving electrode activity, including the steps of providing a polymer as electrochemical catalyst for the electrode or electrodes, preparing a polymer solution by adding water to the polymer, allowing the heating of the polymer solution to a set temperature, immersing the electrode or electrodes in the polymer solution, stirring the solution for at least 10 minutes, removing the electrode or electrodes form the solution and allowing the electrodes to cool to room temperature, and applying a thermal treatment step to provide an activated electrode or electrodes.

According to another embodiment of the present invention, the polymer is a bio-derived polymer. The bio-derived polymer has hydrophilic functional groups. The bio-derived polymer is selected from but not limited to the group consisting of the bio-derived polymer agar powder, chitosan, gelatin, dextran, cellulose, starch, natural rubber, pectin, etc.

According to another embodiment of the present invention, the electrode(s) or electrodes is selected from but not limited to the group consisting of carbon felts, carbon cloth, carbon powders, carbon sheets, carbon fiber, carbon nanotubes etc.

According to another embodiment of the present invention, the solvent for preparing the polymer solution is selected from but not limited to aqueous or any polar solvent.

According to another embodiment of the present invention, the set temperature to which the polymer solution is heated is 80 degrees Celsius (C). Further, the temperature for the preparation of polymer solution may heated in the temperature ranging between 60° C.-90° C.

According to another embodiment of the present invention, the thermal treatment step is done above 350° C. Specifically, the thermal treatment step is done at 400° C. for 2 hours.

According to another embodiment of the present invention, the electrode or electrodes can be negative or positive side electrodes in an energy storage system. The energy storage system is selected from the group including redox flow batteries, vanadium redox flow batteries, supercapacitor, supercapacitor, fuel cell and the like.

According to another embodiment of the present invention, the electrode activity is improved by improving the carbon felts catalytic activity. The carbon felts catalytic activity is improved by increasing the hydrophilicity and number of functional groups on the surface of the carbon fibers during the thermal treatment step. During this step, furans, alkanes and sugars are formed, which all possess a high number of oxygen-containing groups.

According to another embodiment of the present invention, the integration of these functional groups on the surface of the carbon felts may increase the surface-active sites, which may aid in catalyzing electrolyte species (such as vanadium species) at higher current density compared to the only heat-treated carbon felt (HT-CF).

According to another embodiment of the present invention, agar is a biopolymer obtained from the cell walls of some algae. Agar is naturally rich in hydrophilic functional groups and is believed to undergo thermal decomposition at around 350° C. Around this temperature, a single-step reaction occurs, causing mainly the breaking of glycosidic bonds, dehydration and loop opening. The products formed are relatively complex, non-toxic compounds, which can be divided into furans, alkanes and sugars. These functional groups possess a high number of oxygen-containing groups. Integrating these functionalities on the surface of the carbon fibers of the carbon felts can increase the surface-active sites, which more effectively catalyze the electrolyte species, e.g. the vanadium species of a VRFB at higher current density compared to only heat-treated carbon felt (HT-CF).

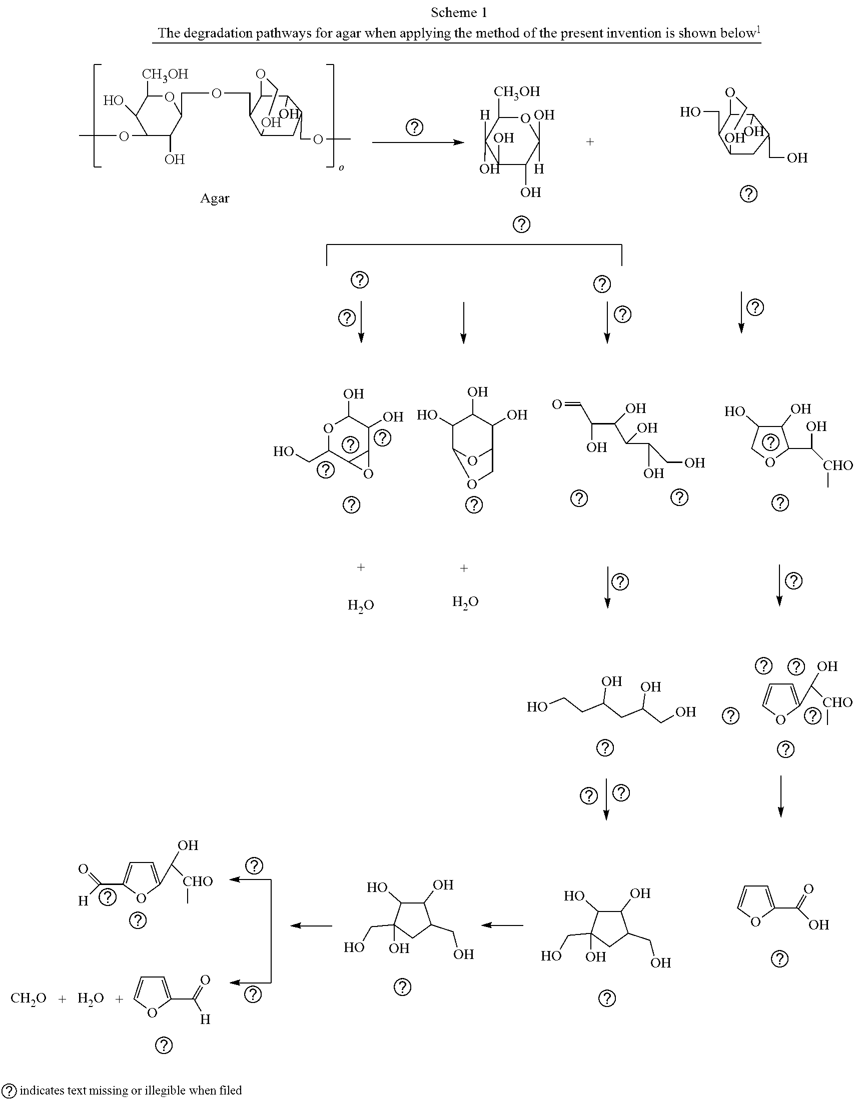

TABLE 1
Table representing the nomenclature of the symbols
and acronyms used throughout the specification.

| Symbol | nomenclature |
|---|---|
| M | mol per litre |
| mA/cm² | milliampere per square centimeter |
| mL | Milliliter |
| mV | Millivolt |
| RFB | redox flow battery |
| SEM | scanning electron microscopy |
| SOC | state of charge |
| V | Volt |
| VRFB | vanadium redox flow battery |
| wt % | weight percent |
| °C | degrees Celsius |
| CE | Coulombic efficiency |
| CF | carbon felt |
| Cm | Centimeter |
| cm2 | square centimeter |
| EDX | energy-dispersive x-ray spectroscopy |
| EE | energy efficiency |
| HT-CF | heat-treated carbon felt |
| L/min | litre per minute |

### Example(s)

The Below Examples are a Way of Explaining the Experimental Representation of the Present Invention and should not Construed to Limit the Scope of the Invention.

A typical redox flow battery (RFB) system consists of stacked cells (where the reactions take place), storage tanks (where the electrolytes are stored), and pumps (to circulate the electrolytes between the stacks and tanks). In many of these systems, carbon felt is used as electrodes.

According to one of the embodiment of the present invention, a two-step activation method of bio-derived agar polymer as electrochemical catalyst (for both negative and positive side electrodes of a vanadium redox flow battery) was done, as follows:

A solution of 0.5 wt % agar polymer was prepared by adding water to agar powder, and a carbon felts electrode was immersed in this solution at 80° C. and stirred for 10 mins. The felts were then cooled to room temperature, whereafter the felts were thermally treated at 400° C. for 2 hours and used as activated electrodes for both negative and positive side electrodes of a VRFB.

The parameters and specifications of the VRFB used for the experimental analysis are listed in Table 2.

TABLE 2

| Parameter | Value | |
|---|---|---|
| Electrolyte volume | 30 | mL |
| Electrolyte concentration | 1.6M | (mol/L) |
| Flow rate | 100 | L/min |
| Area of electrode | 10 | cm² |
| Electrode dimensions | 3.3 * 3 | cm |
| Cut-off voltages (the voltage at which a | 0.8-1.7 | V |
| battery is considered fully discharged or | | |
| flat) | | |
| Current density | 150 | mA/cm² |

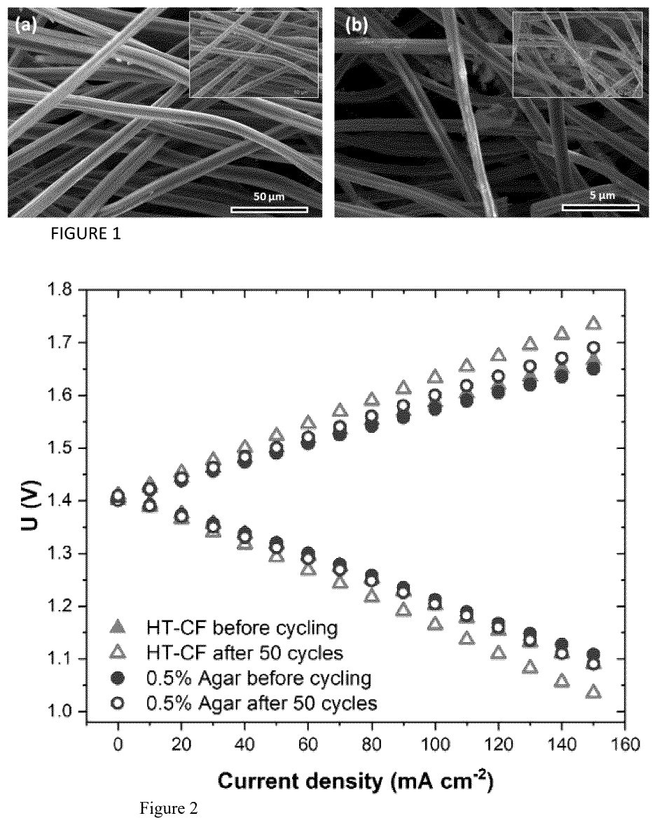

Elemental analysis was done, and the presence of the functional groups on the surface of the fibers were investigated, by means of scanning electron microscopy (SEM) and Energy-Dispersive X-ray Spectroscopy (EDX). Mapping EDX analysis on selected images of the HT-CF reference electrode, demonstrated an oxygen content of 12 wt %, while carbon reached 88 wt %. However, mapping EDX analysis on selected images of the agar-modified CF electrode, demonstrated the ratio of oxygen to carbon was increased, so that 14 wt % was obtained for oxygen and 80 wt % was observed for carbon. In FIG. 1(a), the SEM image of a heat treated-carbon felt electrode is shown as reference, versus an agar-modified carbon felt electrode as shown in FIG. 1(b). The insets on FIGS. 1(a) and (b) show the oxygen mapping EDX on the felts, wherein the oxygen availability on the agar-modified felt is much higher.

Coulombic efficiency (CE), also known as current efficiency, refers to the charge efficiency by which electrons are transferred in batteries. CE is the ratio of the total charge extracted from the battery to the total charge which was put into the battery over a full cycle.

A full-cell lab scale evaluation was performed on the agar-loaded CF (as positive and negative electrode) and compared to thermally treated CF (as reference, as these are usually used in commercial stacks). The polarization curves. i.e., charging and discharging curves, presented in FIG. 2 for the agar-loaded felts, exhibited a decrease of over-potential by increasing the applied currents, as compared to the HT-CF. The same trend was observed after running the cell for 50 cycles—the felts treated with agar in accordance with the method of the present invention exhibited 40 mV and 55 mV lower overpotentials, respectively, for charging and discharging at 150 mA/cm², as compared to the heat-treated felts.

State of charge (SOC) refers to the amount of energy available in a battery at a specific point in time, expressed as a percentage.

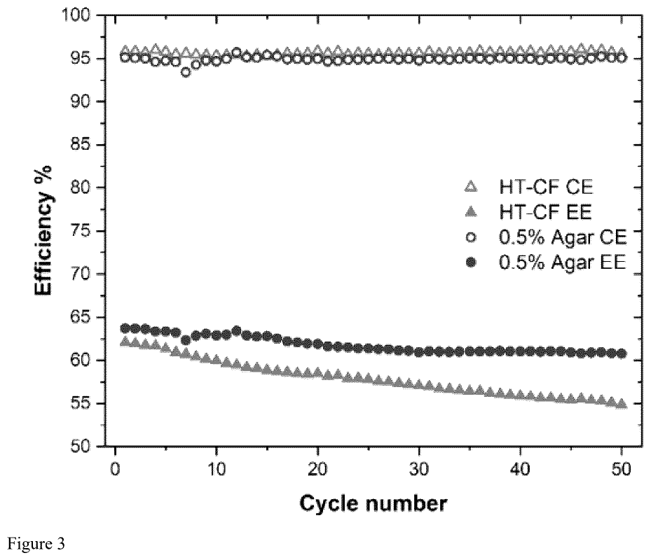

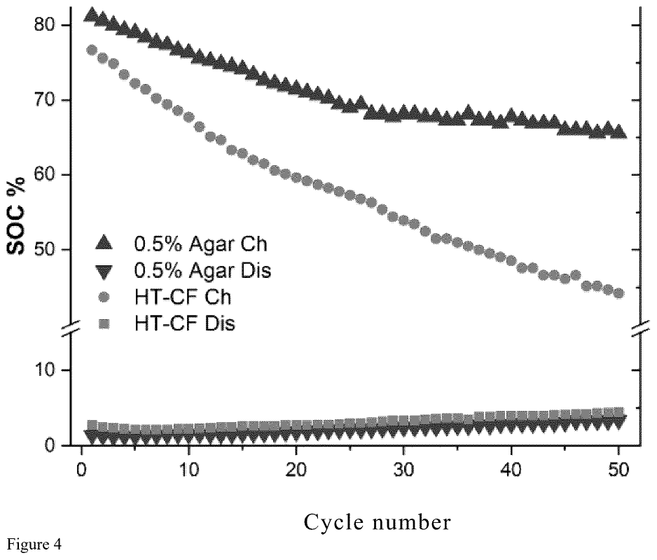

The HT-CF showed faster decay in energy efficiency and state of charge (SOC) (FIGS. 3 and 4), whereas the cell equipped with agar-treated felts exhibit 2% higher energy efficiency at the first cycle and 6% at 50th cycle. The system showed 74% and 80% difference in charge to discharge SOC in the first cycle for HT-CF and agar-treated felts, whereas the same cells showed 40% and 62% difference after running the cells for 50 cycles, respectively. This indicates a 22% higher utilization of the battery when using agar-modified felts.

The presented lower performance of the HT-CF is usually attributed to the high degree of electrode degradation during cycling. Contrary to this, the carbon felts treated with agar in accordance with the method of the present invention showed higher cycling performance and, therefore, lower degradation when compared to the HT-CF.

The modified felts showed higher energy efficiency and discharge capacity, better SOC and lower degradation at a high current density of 150 mA/cm² when compared to heat-treated carbon felts. The superior performance of the carbon felts treated with agar in accordance with the method of the present invention, can be attributed to the presence of additional oxygen containing functional groups on the surface of the fibers, which serve to enhance the wettability and effectively catalyze the electrolyte/vanadium species in the VRFB.

According another embodiment of the present invention, the aforementioned method can be implemented in different types of carbon fibers (such as, carbon felts, carbon paper, carbon cloth).

According to another embodiment of the present invention, the aforementioned method may further be implemented in systems containing different redox reactive species such as vanadium redox flow battery, supercapacitor, electrolysers fuel cell, etc.,

It will be appreciated that various alternative embodiments are also possible in accordance with the present invention. Furthermore, it will be understood that some advantages of the present invention may be attained by selecting some of the features of the present invention without utilizing other features. Accordingly, those skilled in the art will recognize that modifications and adaptations to the present invention may be possible or desirable in certain circumstances and may form part of the present invention.

### REFERENCE(S)

Qian-Qian Ouyang, Zhang Hu, Si-Dong Li, Wei-Yan Quan, Li-Li Wen, Zi-Ming Yang, Pu-Wang Li, Thermal degradation of agar: Mechanism and toxicity of products, Food Chemistry, 264 (2018) 277-283.

1. A method for improving electrode activity, comprising the steps of:
dissolving a linear polymer in a solvent in the concentration ranging between from 0.05 wt % to 5 wt % at a temperature ranging between from 60° C. to 100° C., obtain a polymer solution;
immersing an electrode(s) in the polymer solution at a temperature ranging between 60° C.-100° C. and stirring the solution for the time period ranging between 5 minutes to 15 minutes;
removing the electrode(s) from the polymer solution and allowing the electrode(s) to cool at the temperature ranging between 15° C. to 30° C.; and,
thermally treating the obtained electrode(s) at a temperature ranging between 350° C. to 420° C. for a time period ranging between 1-10 hours, for receiving activated electrode with improved activity.

2. The method as claimed in claim 1, wherein the linear polymer is a bio-derived polymer having hydrophilic functional groups.

3. The method as claimed in claim 1, wherein the bio-derived polymer is selected from the group consisting of agar powder, chitosan, gelatin, dextran, cellulose, starch, natural rubber, pectin, etc.

4. The method as claimed in claim 1, wherein the weight percent polymer solution is in the range of 0.05 wt %-5 wt %.

5. The method as claimed in claim 1, wherein the electrode(s) is selected from the group consisting of carbon felts, carbon cloth, carbon powders, carbon sheets, carbon fiber, and carbon nanotubes.

6. The method as claimed in claim 1, wherein the solvent is selected from aqueous solvent.

7. The method as claimed in claim 1, wherein the set temperature to which the polymer solution is heated is in the temperature ranging between 60° C.-100° C.

8. The method as claimed in claim 1, wherein the thermal treatment step is done in the temperature ranging between 350° C.-420° C. for the time period ranging between 1-10 hours.

9. The method as claimed in claim 1 a wherein the electrode(s) are negative and/or positive side electrodes in an energy storage system.

10. The method as claimed in claim 9, wherein the energy storage system is selected from the group including redox flow batteries (RFB), vanadium redox flow batteries (VRFB), supercapacitors, electrolysers and fuel cells.

11. The method as claimed in claim 1, wherein the electrode activity is improved by improving electrode catalytic activity.

12. The method as claimed in claim 1, wherein the electrode catalytic activity is improved by increasing the hydrophilicity and number of functional groups on the surface of the electrodes during the thermal treatment step.

13. The method as claimed in claim 12, wherein the increasing number of functional groups is achieved by the integration of oxygen-containing groups on the surface of the electrodes.

14. The method as claimed in claim 11, wherein the integration of oxygen-containing group is selected from the group consisting of alcohols, ether, aldehydes, ketone, carboxylic acid, ester, acid halides, etc.

15. The method as claimed in claim 11, wherein the integration of oxygen-containing groups increase the surface-active sites, aiding in catalyzing electrolyte species at higher current density compared to only heat-treated electrode.
